(19) United States
(12) Patent Application Publication
(10) Pub. No.: US 2024/0339657 A1
(43) Pub. Date: Oct. 10, 2024

(54) SLURRY COMPOSITION FOR ALL-SOLID-STATE SECONDARY BATTERY AND ALL-SOLID-STATE BATTERY COMPRISING SAME

(71) Applicants: Byung Joo KIM, Seoul (KR); Byung Ju KIM, Daejeon (KR)

(72) Inventor: Byung Ju KIM, Daejeon (KR)

(21) Appl. No.: 18/574,559

(22) PCT Filed: Jun. 30, 2022
(86) PCT No.: PCT/KR2022/009418

§ 371 Date: Dec. 27, 2023

(30) Foreign Application Priority Data
Jun. 30, 2021 (KR) 10-2021-0085320

(51) Int. Cl. H01M 10/0565

(52) U.S. Cl. CPC H01M 10/0565; H01M 2300/0082

(57) ABSTRACT

Disclosed is a slurry composition for a solid-state secondary battery containing a binder and an organic electrolyte, wherein the binder contains a polyimide-based compound.

### TECHNICAL FIELD

The present invention relates to a slurry composition for solid-state secondary batteries and a solid-state battery containing the same.

### BACKGROUND ART

Lithium-ion batteries are currently widely used in electronic devices due to much higher energy density per unit volume than other battery systems. Lithium-ion batteries are finding applications from small batteries to automobiles and energy storage devices.

However, commonly known lithium-ion batteries basically use liquid electrolytes, thus continuing to cause safety problems related to explosion or ignition.

As an alternative to such liquid electrolytes, solid electrolytes, which are broadly classified into three types: sulfide-, polymer-, and oxide-based electrolytes, have been proposed. However, sulfide-based solid electrolytes are difficult to handle due to high reactivity with the atmosphere and/or oxide-based cathode active materials such as LiCoO₂, while polymer-based solid electrolytes have poor thermal stability and thus deteriorate at high temperatures. In addition, oxide-based solid electrolytes have problems of relatively low ion conductivity of 10⁻⁶ to 10⁻⁵ S/cm.

Therefore, in order to commercialize mid-to large-sized lithium ion batteries, it is necessary to overcome the disadvantages of the high reactivity or low ion conductivity of generally known solid electrolytes, while overcoming the problem of safety of liquid electrolytes. However, research on this remains insufficient.

### DISCLOSURE

### Technical Problem

Therefore, it is an object of the present invention to provide a slurry composition for solid-state secondary batteries that uses a specific binder with increased flame retardancy and adhesive strength to a solid-state electrolyte composition free of an inorganic substance, thereby exhibiting significantly improved ion conductivity and electrochemical stability, while solving safety problems of liquid electrolytes.

### Technical Solution

In accordance with one aspect of the present invention, the above and other objects can be accomplished by the provision of a slurry composition for a solid-state secondary battery containing a binder and an organic electrolyte, wherein the binder contains a polyimide-based compound.

The polyimide-based compound may be fluorinated polyimide (FPI).

The organic electrolyte may be linear or cyclic and comprise at least one selected from carbonates, esters, ethers, polystyrene, polyethylene oxide, polypropylene oxide, polymethyl methacrylate, polyacrylonitrile, and polysiloxane.

The slurry composition may not contain an inorganic electrolyte.

The slurry composition may further contain at least one selected from a first organic compound, a lithium salt, and an additive.

The fluorinated polyimide (FPI) may be present in an amount of 1 to 20% by weight based on the total weight of the slurry composition for a solid-state secondary battery.

The binder may not include a polyvinylidene fluoride (PVdF)-based binder.

The slurry composition may further contain at least one selected from an electrode active material and a conductive material.

The slurry composition may have an ion conductivity of 2.0×10⁻² S/CM or more.

In accordance with another aspect of the present invention, provided is a solid-state secondary battery containing the slurry composition for a solid-state secondary battery.

### Advantageous Effects

The slurry composition for solid-state secondary batteries can significantly improve ion conductivity and electrochemical stability, while solving safety problems of liquid electrolytes, by applying a specific binder with increased flame retardancy and adhesive strength to a solid-state electrolyte composition free of an inorganic substance.

### DESCRIPTION OF DRAWINGS

FIG. 1 shows the ion conductivity of solid electrolytes according to Examples and Comparative Examples of the present invention.

FIG. 2 shows the results of electrochemical stability test of solid electrolytes according to Examples and Comparative Examples of the present invention.

### BEST MODE

The advantages and features of the present invention and methods for achieving the same will be clearly understood with reference to the embodiments described in detail below. However, the present invention is not limited to the embodiments described herein and may be embodied in other forms.

As used herein, expressions such as “comprising” should be understood as open-ended terms that may include other embodiments.

As used herein, the terms “preferred” and “preferably” refer to embodiments of the present invention that may provide certain advantages under specific circumstances. However, other embodiments may also be preferred under the same or different circumstances. In addition, when “one or more preferred embodiments” is referred, it does not mean that other embodiments are not useful and does not exclude other embodiments from the scope of the invention.

The slurry composition for a solid-state secondary battery contains a binder and an organic electrolyte, and the binder contains a polyimide-based compound.

As used herein, the term “solid-state” refers to a state other than a gas or liquid and may include a general solid state or a gel state.

The present invention provides a slurry composition for a solid-state secondary battery that contains an organic electrolyte and a polyimide-based compound, thereby providing effects of improving electrochemical stability and ion conductivity.

As a more preferred embodiment, the binder may be present in an amount of 8 to 16% by weight based on the total weight of the slurry composition for a solid-state secondary battery.

As a more preferred embodiment, the polyimide-based compound may be fluorinated polyimide (FPI).

The present invention is effective in improving electrochemical stability and ion conductivity using an organic electrolyte in combination with a fluorinated polyimide (FPI) binder.

As a more preferable embodiment, the binder may not include a polyvinylidene fluoride (PVdF)-based binder. For example, the binder may not contain poly (vinylidene fluoride-co-hexafluoropropylene) (PVdF-HFP).

The polyvinylidene fluoride (PVdF)-based binder is widely used in the art. The present invention provides effects of significantly improving electrochemical stability and ion conductivity using an organic electrolyte in combination with fluorinated polyimide (FPI), instead of the polyvinylidene fluoride binder.

In addition, the fluorinated polyimide (FPI) has an effect of increasing flame retardancy due to higher thermal stability than polyvinylidene fluoride (PVdF). In addition, the fluorinated polyimide (FPI) also has the effect of suppressing the formation of cracks in the electrode. In addition, the fluorinated polyimide (FPI) also has the effect of improving the lifespan characteristics of the battery through uniform SEI formation and suppression of metal elution.

As a more preferred embodiment, the fluorinated polyimide (FPI) may be present in an amount of 1 to 20% by weight, or 5 to 10% by weight, based on the total weight of the slurry composition for a solid-state secondary battery.

In addition, as a more preferred embodiment, the fluorinated polyimide may be present in an amount of 50 to 80% by weight, or 60 to 70% by weight, based on the total weight of the binder.

As a more preferred embodiment, the binder may further contain hydroxypropyl cellulose.

As a more preferred embodiment, the hydroxypropyl cellulose may be present in an amount of 20 to 50% by weight, or 30 to 40% by weight, based on the total weight of the binder.

The slurry composition for a solid-state secondary battery according to an embodiment of the present invention contains an organic electrolyte.

For example, the organic electrolyte may be a linear or cyclic, and contain at least one selected from carbonate, ester, and ethers contained and prepared as organic solvents.

For example, the carbonate includes at least one selected from ethylene carbonate (EC), propylene carbonate (PC), 1,2-butylene carbonate, 2,3-butylene carbonate, 1,2-pentylene carbonate, 2,3-pentylene carbonate, vinylene carbonate, fluoroethylene carbonate (FEC), dimethyl carbonate (DMC), diethyl carbonate (DEC), dipropyl carbonate, ethylmethyl carbonate (EMC), methylpropyl carbonate, and ethylpropyl carbonate.

For example, the ester includes at least one selected from methyl acetate, ethyl acetate, propyl acetate, methyl propionate, ethyl propionate, propyl propionate, butyl propionate, γ-butyrolactone, γ-valerolactone, γ-caprolactone, σ-valerolactone, and ϵ-caprolactone.

For example, the ether may include at least one selected from dimethyl ether, diethyl ether, dipropyl ether, methyl ethyl ether, methyl propyl ether, and ethyl propyl ether.

More preferably, the organic electrolyte may contain a mixed solvent of ethylene carbonate, which has a high permittivity, and propylene carbonate, which has a relatively low melting point compared to ethylene carbonate.

In addition, the organic electrolyte may contain at least one polymer selected from polystyrene, polyethylene oxide, polypropylene oxide, polymethyl methacrylate, polyacrylonitrile, and polysiloxane.

As a more preferred embodiment, the organic electrolyte may be present in an amount of 40 to 65% by weight, or 50 to 60% by weight, based on the total weight of the slurry composition for a solid-state secondary battery.

As a more preferred embodiment, the slurry composition for a solid-state secondary battery may not contain an inorganic electrolyte.

Among various types of solid electrolytes, composite solid electrolytes containing active inorganic fillers in a polymer matrix are known to be the most advantageous in achieving excellent ion conductivity and excellent interfacial contact with electrodes.

However, the present invention has effects of overcoming the problems of difference in ion conductivity and interfacial resistance of organic and inorganic substances and of significantly improving ion conductivity owing to smooth ion mobility by removing inorganic substances from organic-inorganic composite solid electrolytes and using a polyvinylidene fluoride-based binder.

The present invention can overcome the disadvantage of conventional sulfide-based solid electrolyte, such as difficulty in handling conventional sulfide-based solid electrolytes due to high reactivity with the atmosphere and/or oxide-based cathode active materials, and the disadvantage of the low ion conductivity of conventional oxide-based solid electrolytes by removing inorganic substances and improving electrochemical stability using polyvinylidene fluoride-based binders.

In an embodiment, the slurry composition for a solid-state secondary battery of the present invention may not contain an oxide-, phosphate-, nitride-, and sulfide-based inorganic electrolytes.

For example, as the inorganic electrolyte not contained in the slurry composition, the oxide-based electrolyte may be lithium lanthanum zirconium oxide (LLZO) or lithium lanthanum titanium oxide (LLTO), the phosphate-based electrolyte may be lithium aluminum titanium phosphate (LATP), aluminum germanium phosphate (LAGP) or lithium silicon titanium phosphate (LSTP), the nitride-based electrolyte may be lithium phosphorus oxynitride (LiPON), and the sulfide electrolyte may be thio-LISICON.

The slurry composition for a solid-state secondary battery may further contain at least one selected from a first organic compound, a lithium salt, and an additive.

The first organic compound that may be contained in the slurry composition for a solid-state secondary battery according to an embodiment of the present invention includes: linear aliphatic hydrocarbons such as hexane; cyclic aliphatic hydrocarbons such as cyclopentane and cyclohexane; aromatic hydrocarbons such as toluene and xylene; ketones such as ethyl methyl ketone, diisobutyl ketone, and cyclohexanone; esters such as ethyl acetate, butyl acetate, butyl butyrate, γ-butyrolactone, and ϵ-caprolactone; acrylonitriles such as acetonitrile and propionitrile; ethers such as tetrahydrofuran, ethylene glycol diethyl ether, and n-butyl ether; alcohols such as methanol, ethanol, isopropanol, ethylene glycol, and ethylene glycol monomethyl ether; and amides such as N-methylpyrrolidone and N,N-dimethylformamide.

In a more preferred embodiment, the first organic compound may include methylpyrrolidone (N-methyl-2-pyrrolidone, NMP). The present invention can improve performance of solid-state batteries using an inorganic substance-free electrolyte, and N-methyl-2-pyrrolidone (NMP) in combination with a polyimide-based binder, especially fluorinated polyimide (FPI).

In a more preferred embodiment, the first organic compound may further contain ketone. In this case, the ketone may be acetone.

In a more preferred embodiment, the first organic compound may be present in an amount of 20 to 50% by weight, or 30 to 40% by weight, based on the total weight of the slurry composition for a solid-state secondary battery.

The lithium salt that may be contained in the slurry composition for a solid-state secondary battery according to an embodiment of the present invention may include at least one selected from LiCl, LiBr, LiI, LiClO₄, LiBF₄, LiB₁₀Cl₁₀, LiPF₆, LiCF₃SO₃, LiCH₃CO₂, LiCF₃CO₂, LiAsF₆ , LiSbF₆, LiAlCl₄, LiAlO₄, LiCH₃So₃, LiFSI (lithium fluorosulfonyl imide, LiN(SO₂F)₂), LiTFSI (lithium (bis)trifluoromethanesulfonimide, LIN(SO₂CF₃)₂) and LiBETI (lithium bisperfluoroethanesulfonimide, LiN(SO₂C₂F₅)₂), LiPF₆, LiBF₄, LiCH₃CO₂, LiCF₃CO₂, LiCH₃SO₃, LIFSI, LiTFSI and LiN(C₂F₅SO₂)₂. In a more preferred embodiment, LiPF₆ and/or LiFSi can improve the performance of the solid-state battery of the present invention.

The additive that may be present in the slurry composition for a solid-state secondary battery according to an embodiment of the present invention includes fluoroethylene carbonate (FEC), vinylene carbonate (VC), propanesultone (PS), propanylsultone (PRS), and phosphazene, but is not particularly limited thereto.

When the slurry composition for a solid-state secondary battery according to an embodiment of the present invention is used to form a solid electrolyte layer, it may not contain an electrode active material and a conductive material.

However, when the slurry composition for a solid-state secondary battery according to an embodiment of the present invention is used in an electrode mixture layer, it may further contain an electrode active material and/or a conductive material.

For example, the cathode active material is lithium-containing transition metal oxide as a compound capable of reversibly intercalate and deintercalate lithium, but is not particularly limited thereto.

For example, any material may be used as the anode active material as long as it can reversibly intercalate or deintercalate lithium ions, or can react with lithium ions to reversibly form a lithium-containing compound.

The conductive material may be contained in the electrode mixture layer formed by incorporating the slurry composition for a solid-state secondary battery of the present invention and the conductive material aims at ensuring electrical contact between electrode active materials. When the electrode mixture layer contains the conductive material, the electrical resistance of the electrode mixture layer can be efficiently reduced. The slurry composition for a solid-state secondary battery according to an embodiment of the present invention has an ion conductivity of 2.0×10⁻² S/CM, 2.5×10⁻² S/CM or more, 3.0×10⁻² S/CM or more, or 3.5×10⁻² S/CM or more.

The solid-state secondary battery according to an embodiment of the present invention contains the slurry composition for a solid-state secondary battery.

The solid-state secondary battery includes a cathode, a solid electrolyte layer, and an anode, and at least one of the cathode composite layer of the cathode, the anode composite layer of the anode, and the solid electrolyte layer according to the embodiment of the present invention may be contained in the slurry composition for a solid-state secondary battery.

The solid-state secondary battery may adopt any one of structures, materials, and manufacturing methods of commonly used solid-state secondary batteries and is not particularly limited.

Hereinafter, specific embodiments of the present invention will be described.

### COMPARATIVE EXAMPLES AND EXAMPLES

First, a binder and a first organic compound in the composition shown in Table 1 below were stirred to prepare a binder solution and then an electrolyte having the composition shown in Table 1 below was added, followed by further stirring to synthesize a solid electrolyte.

In the following table, LiPF₆/LiFSi 0.5/0.5M in EC/PC ½ (v/v)+VC 2% was used as the organic electrolyte.

In addition, lithium silicon titanium phosphate (LSTP) was used as the inorganic electrolyte.

TABLE 1

| | Binder | | | | | | | |
|---|---|---|---|---|---|---|---|---|
| | | | Hydroxypropyl | Co-solvent | | Electrolyte | | |
| Item | PVdF-HFP | FPI | cellulose | NMP | Acetone | Organic | Inorganic | Total |
| Comparative | 8% | | 4% | 18% | 18% | 47% | 6% | 100% |
| Example 1 | | | | | | | | |
| Comparative | 8% | | 4% | 18% | 18% | 53% | | 100% |
| Example 2 | | | | | | | | |
| Example 1 | | 8% | 4% | 18% | 18% | 47% | 6% | 100% |
| Example 2 | | 8% | 4% | 18% | 18% | 53% | | 100% |

### Experimental Example

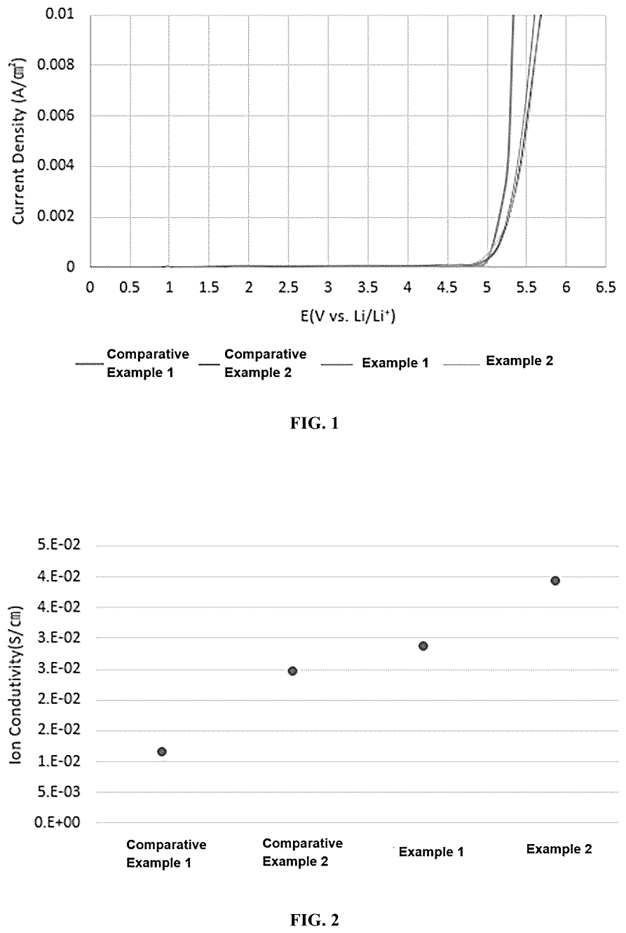

The total ion conductivity and electrochemical stability of the prepared solid electrolyte were measured and the results are shown in FIGS. 1 and 2, and Table 2 below.

TABLE 2

| Item | Ionic conductivity (S/cm) |
|---|---|
| Comparative Example 1 | 1.16.E−02 |
| Comparative Example 2 | 2.47.E−02 |
| Example 1 | 2.88.E−02 |
| Example 2 | 3.93.E−02 |

As can be seen from FIGS. 1 and 2, and Table 2, the ion conductivity and electrochemical stability of the Examples of the present invention are significantly improved compared to Comparative Examples.

1. A slurry composition for a solid-state secondary battery comprising a binder and an organic electrolyte,
wherein the binder comprises a polyimide-based compound.

2. The slurry composition according to claim 1, wherein the polyimide-based compound is fluorinated polyimide (FPI).

3. The slurry composition according to claim 1, wherein the organic electrolyte is linear or cyclic and comprises at least one selected from carbonates, esters, ethers, polystyrene, polyethylene oxide, polypropylene oxide, polymethyl methacrylate, polyacrylonitrile, and polysiloxane.

4. The slurry composition according to claim 1, wherein the slurry composition does not comprise an inorganic electrolyte.

5. The slurry composition according to claim 1, further comprising at least one selected from a first organic compound, a lithium salt, and an additive.

6. The slurry composition according to claim 2, wherein the fluorinated polyimide (FPI) is present in an amount of 1 to 20% by weight based on a total weight of the slurry composition for a solid-state secondary battery.

7. The slurry composition according to claim 1, wherein the binder does not comprise a polyvinylidene fluoride (PVdF)-based binder.

8. The slurry composition according to claim 1, further comprising at least one selected from an electrode active material and a conductive material.

9. The slurry composition according to claim 1, wherein the slurry composition has an ion conductivity of 2.0×10⁻² S/CM or more.

10. An solid-state secondary battery comprising the slurry composition for a solid-state secondary battery according to claim 1.
